(19) United States
(12) Patent Application Publication
(10) Pub. No.: US 2013/0020343 A1
(43) Pub. Date: Jan. 24, 2013

(54) LUMBER HANDLING APPARATUS

(71) Applicants: Edward Domenick Serrano, Beckenham (AU); Jeffrey Clifford Serrano, Queens Park (AU)

(72) Inventors: Edward Domenick Serrano, Beckenham (AU); Jeffrey Clifford Serrano, Queens Park (AU)

(73) Assignee: Vekta Automation Pty Ltd

(21) Appl. No.: 13/220,476

(22) Filed: Aug. 29, 2011

(30) Foreign Application Priority Data
Jul. 20, 2011 (AU) 2011204864

(51) Int. Cl. B65G 59/00

(52) U.S. Cl. 221/1; 221/251; 221/226

(57) ABSTRACT

A system and apparatus for dispensing lumber is described. The apparatus includes a pusher, such as a chain driven lug, which pushes against the side of a row of lumber, thus sequentially pushing the top row of a lumber pack into a transport system. The apparatus also includes a hydraulic lift which enables the lumber pack to be moved upwards for the dispensing of subsequent rows.

### FIELD

This application relates to the handling of sawn timber and similar products, and particularly the dispensing of lumber from packs for processing.

### BACKGROUND

When processing lumber it is necessary to take long boards of timber and saw them into required lengths. Timber is typically supplied in packs of stacked boards. Packs may be, for instance, in the order of 15 boards wide and 15 boards high

Traditionally, it has been necessary for workers to move each board in turn to a saw in order for it to be cut to a required length. As will be appreciated, this is a highly labour intensive operation.

It is therefore desirable to automate the supply of boards to a saw by means of a suitable mechanism. Such automation presents challenges, however.

Boards are heavy and bulky, and for this reason gravity feed mechanisms are impractical. Instead, the mechanism must be equipped to remove individual boards from the top of a pack. As the height of a pack changes as boards are removed, the mechanism must be able to adapt for this.

The width of boards is generally constant within a pack, but may vary between packs, and for different applications. Accordingly the mechanism must be equipped to manage a variety of board widths.

One mechanism known to the applicant which attempts to overcome these problems does so by positioning wood packs beneath an overhead rail onto which is located a vertically extending suction plate. The suction plate is positioned above a board to be retrieved, and then lowered to contact this board. A vacuum is applied to the suction plate in order to hold the board in place. The suction plate is then raised to the rail, and moves along the rail until the board is over a destination conveyor. The suction plate is then lowered until the board is close to the conveyor, at which time the vacuum ceases and the board is allowed to fall into position.

Another mechanism known to the applicant uses a similar overhead rail concept, with a vertically extending grabbing mechanism which uses two self-tapping screw threads to bore into the board and hold into position. The threads are reversed when the board is ready to be dropped to its destination. This has an advantage over the suction plate in that the connection is much more secure, and the likelihood of a board being dropped whilst being moved is lessened. On the other hand, there is a significant disadvantage in that two holes are bored into the board.

Both of these mechanisms have further disadvantages. The mechanism must be able to identify a targeted board, and to locate directly above it. This can require highly complex measuring devices such as laser guidance systems. Should boards not be taken in an appropriate sequence, the pack may become unstable and boards may fall over. Finally, the arrangements are sensitive to changes in layout and dimensions, which suggests that scaling of these mechanisms for different sized operations is at best difficult.

It would be advantageous to provide an alternative lumber handling mechanism which seeks to avoid some of the difficulties associated with known mechanisms.

### SUMMARY

According to one implementation, there is provided a lumber dispensing apparatus having:

a pack-supporting platform which is able to be moved vertically;

a row-moving pusher which is able to be moved horizontally;

a rotation-preventing guide located above the pack-supporting platform; and

a lumber restraint located alongside the pack-supporting platform, whereby

when the pack-supporting platform contains a pack of timber, comprising boards arranged in rows and having a top-most row:

the pack-supporting platform is arranged to raise the pack until the top-most row is in position adjacent the row-moving pusher; and

the row-moving pusher is arranged to engage the top-most row of timber at an end remote from the lumber restraint, and to push the top-most row of timber in a transverse direction over the lumber restraint, the lumber restraint being lower by a vertical displacement less than the depth of two boards than a highest part of the top-most row when the pack is raised.

It will be appreciated that a member is provided next to the lumber restraint to catch each board as it is dispensed, and to move it into position for further processing.

In accordance with a second implementation, there is provided a method of dispensing lumber from a pack, the pack comprising boards of timber arranged in rows, the method including the steps of:

locating the pack beneath a rotation-preventing guide; raising the pack until the topmost row is adjacent the rotation-preventing guide;

pushing the top-most row in a transverse direction so that boards of the top-most row sequentially fall over a side of the pack; and

subsequently raising the pack until the new topmost row is adjacent the rotation-preventing guide.

It is preferred that the lumber dispensing apparatus is associated with a lumber transport system, which may include a series of continuous loop transporters, such as transfer chains. The lumber dispensing apparatus may be equipped to operate in series, whereby a plurality of lumber dispensing apparatuses are arranged in sequence. Each of these apparatuses may include a portion of the lumber transport system located above the rotation-preventing guide.

Each lumber dispensing apparatus may be associated with a lumber receiver adjacent the lumber restraint, onto which the dispensed lumber is pushed. The lumber transport system may provide an alternative route for lumber to reach the lumber receiver: it may be pushed from the pack onto the receiver, or may be brought from another pack, over the rotation-preventing guide, to the lumber receiver.

### BRIEF DESCRIPTION OF THE DRAWINGS

It will be convenient to further describe several implementations of the lumber handling apparatus, including both lumber dispensing apparatus and lumber transport system. Other embodiments are possible, and consequently the particularity of the following description is not to be understood as superseding the generality of the preceding description. In the drawings:

FIG. 1 is a side view of a lumber dispensing apparatus in accordance with the present invention;

FIG. 2 is a upward-looking cross section through line A-A of the lumber dispensing apparatus of FIG. 1;

FIG. 3 is an enlarged view of a lumber restraint within the lumber dispensing apparatus of FIG. 1;

FIG. 4 is a plan view of the lumber restraint of FIG. 3;

FIG. 5 is a perspective of a lumber dispenser utilising three of the lumber dispensing apparatuses of FIG. 1; and

FIG. 6 is a schematic perspective of a lumber handling apparatus including six of the lumber dispensers of FIG. 5.

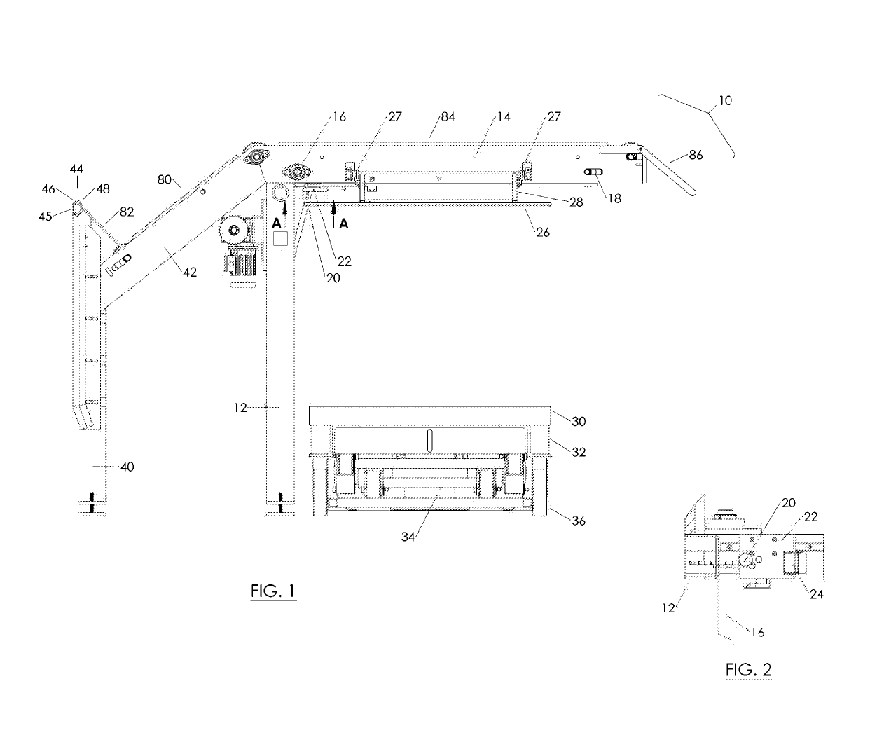

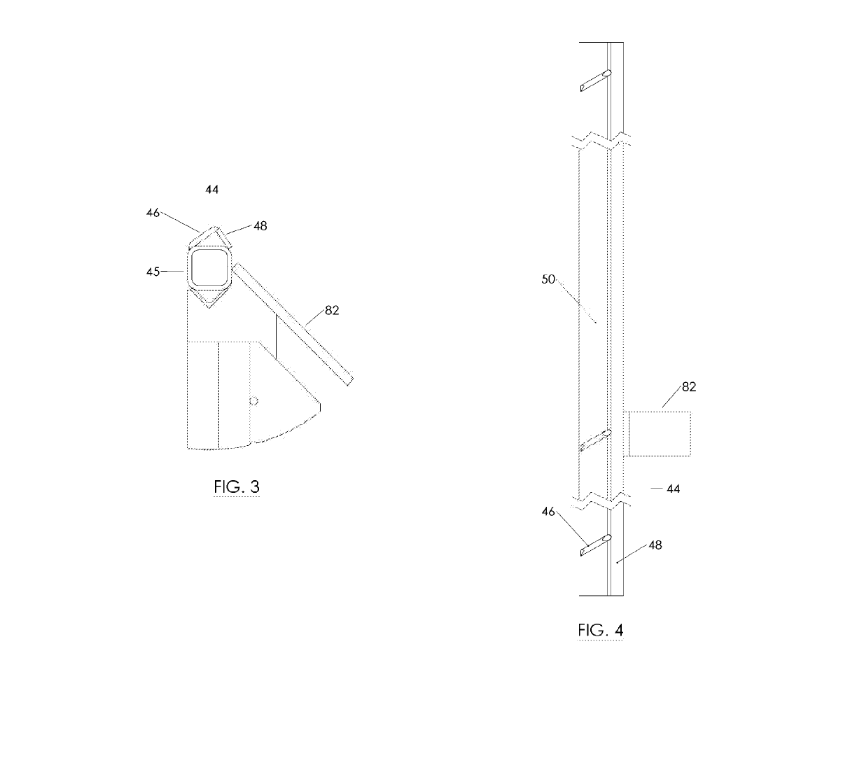

### DETAILED DESCRIPTION OF PREFERRED EMBODIMENTS

Referring to the Figures, there can be seen in FIG. 1 a lumber dispensing apparatus 10, having an upright 12 and a cantilevered cross bar 14.

The cross bar 14 houses a dispensing drive mechanism, in the form of a continuous loop dispensing chain drive. The chain drive is located between a drive shaft 16 and an idler sprocket 18, located at longitudinally spaced ends of the cross bar 14.

The chain drive operates a row-moving pusher in the form of a dispensing lug 20. The dispensing lug 20 extends vertically downward from a carriage 22, which is coupled to the chain drive by a mount block 24.

Rotation-preventing guides 26 are located on either side of the cross bar 14. The guides 26 are laterally spaced from the cross bar 14, and are held into a position vertically beneath the cross bar 14 by brackets 28. The brackets 28 are pivoted against the cross bar 14, and are resiliently biased by torsion springs 27 or other resilient members to maintain the guides 26 in a neutral position slightly beneath the height of the lug 20.

The guides 26 are elongate, and are parallel to a longitudinal axis of the cross bar 14. In their neutral position the guides 26 are located below the cross bar 14.

The dispensing apparatus 10 also includes a pack supporting platform 30. The platform 30 is mounted onto a trolley 32, sized and shaped to locate over a hydraulic lift 34. The hydraulic lift 34 is located directly beneath the cross bar 14, and allows the platform 30 to be raised from an initial position wherein wheels 36 of the trolley 32 are in contact with the floor to a final position wherein the platform 30 may be in contact with the guides 26.

The dispensing apparatus further includes a second upright 40. In FIG. 1, a second upright 40 can be seen spaced from the first upright 12 on the opposite side to that of the hydraulic lift 34. This second upright 40, although coupled to the first upright 12 by an angled connecting beam 42, is more correctly considered as being associated with an adjacent dispensing apparatus 10 as will be seen below.

The second upright 40 includes a lumber restraint 44 located at the upper end thereof. The lumber restraint 44 comprises a length of square section tubing 45 extending horizontally, in the horizontal direction perpendicular to the guides 26. The lumber restraint 44 has a plurality of receiving guides 46 spaced along its length. The receiving guides 46, which in the embodiment shown are formed from bars welded into position, extend upwardly at an angled of about 35° to the horizontal, from a low point along the front top corner of the square section tubing 45 to a high point above a top face of the square section tubing 45. The lumber restraint 44 also includes a dispensing guide 48 which is formed from flat bar extending between the high point of the receiving guides 46 to the top rear corner of the square section tubing 45. The dispensing guide 48 is thus angled at about 55° to the horizontal.

It will be appreciated that a gap 50 extends between neighbouring receiving guides 46, and anything entering this gap will be trapped beneath the dispensing guide 48.

The lumber restraint 44 is located at a height immediately below that of the lug 20.

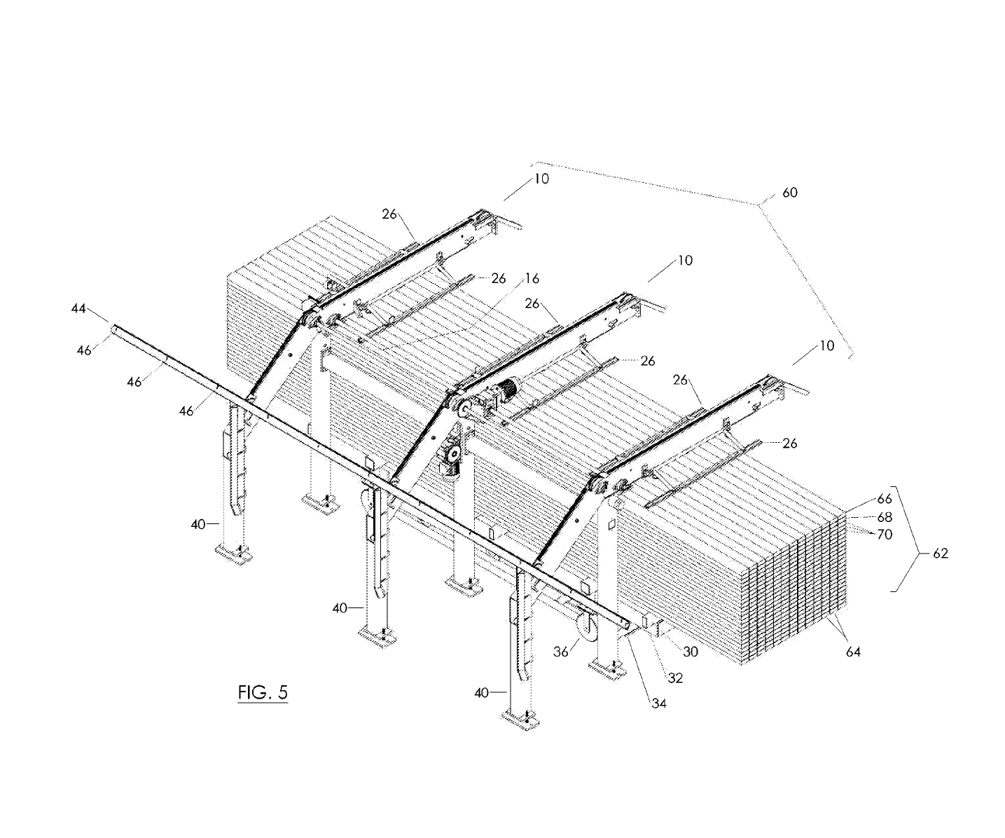

FIG. 5 shows a lumber dispenser 60, which is formed by three lug dispensing apparatuses 10 laterally spaced. It will be noted that the three dispensing apparatuses 10 share certain elements: there is a common drive shaft 16 extending through all three cross bars 14; there is a single trolley 32 and hydraulic lift 34; and a single lumber restraint 44.

Use of the lumber dispenser 60 will now be described.

A pack of lumber 62 is first loaded onto a trolley 32. As shown in FIG. 5, a pack 62 comprises boards 64 stacked so as to have a top row 66, a second row 68 and subsequent rows 70. The trolley 32 is then positioned over the hydraulic lift 34 such that the boards 64 are parallel to the lumber restraint 44.

The hydraulic lift 34 then raises the platform 30 until the top row 66 is level with the lugs 20. This has the effect of raising the guides 26, which are held in contact with the top row 66 by virtue of the torsion springs 27.

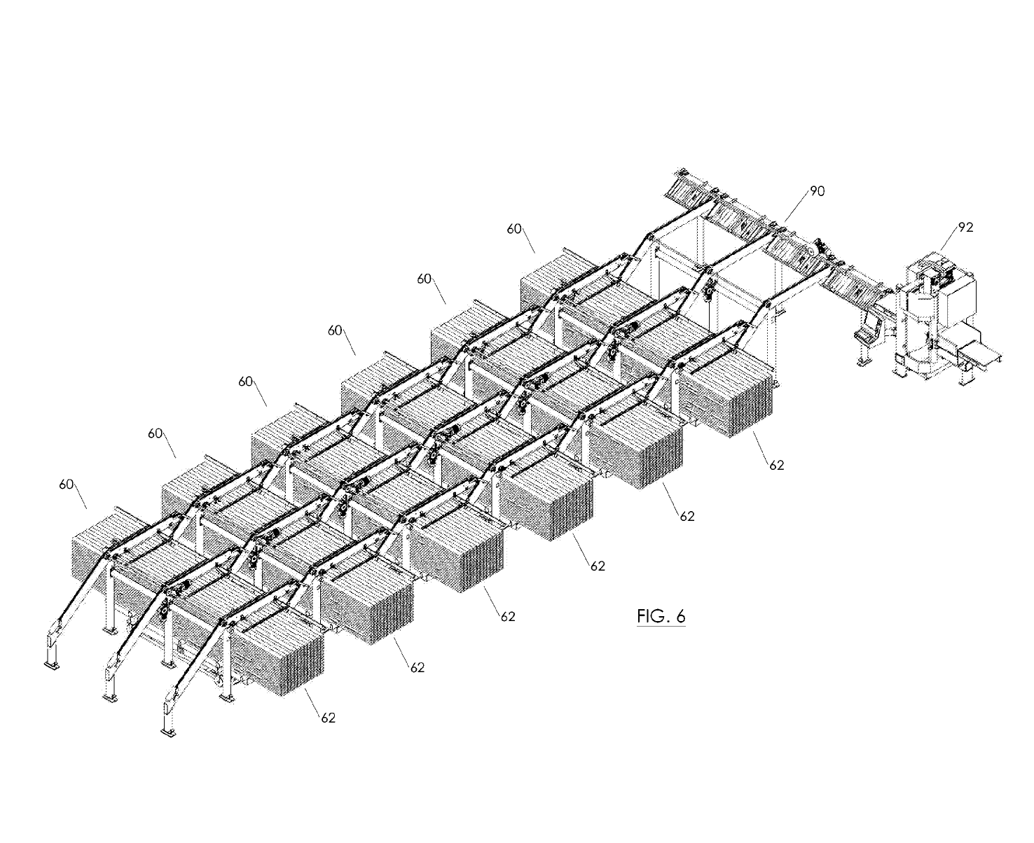

As can be seen in FIG. 6, the lumber restraint 44 connected to an adjacent lumber dispenser 60 is positioned next to the platform 30, on the other side of the platform 30 to the first uprights 12. The arrangement is such that the square section tubing 45 of the lumber restraint 44 locates against the second row 68 of the pack 62, once the top row 66 is raised to the appropriate height.

Rotation of the drive shaft 16 causes simultaneous movement of the carriages 22 and their associated lugs 20 along the cross bars 14. The lugs 20 engage with an innermost board 64 of the top row 66, and push it in a direction away from the first upright 12. This board 64 engages its neighbouring board 64, and so on, until the entire top row 66 is being pushed away from the first upright 12. The boards are held down by the guides 26, which prevent rotation of any one board.

The outermost board 64 of the top row 66 is pushed over the lumber restraint 44, and falls to a lumber receiver which is part of the lumber transport system to be described below. The lumber transport system carries the outermost board 64 away, in time for the next board 64 to be pushed over the lumber restraint 44.

Any slats (that is, small pieces of timber used for stabilising purposes) within the pack 62 will fall into the gap 50.

When the entire top row 66 has been pushed over the lumber restraint 44, the direction of drive shaft rotation is reversed and the lugs 20 return to their initial position. The hydraulic lift 34 then raises the platform until the previous second row 68, now a new top row 66, is in position for dispensing.

The lumber handling apparatus has a plurality of lumber dispensers 60, together with the lumber transport system.

The lumber transport system centres around a number of continuous loop transporters, being continuous chains having lumber engaging lugs located regularly along their length.

A first such transport chain 80 is located along the connecting beam 42. A lumber guide 82, being simply a short length of steel, leads from the lumber restraint 44 to the base of the connecting beam 42. This constitutes the lumber receiver. The first transport chain 80 is then arranged to transport a board 64 from the lumber receiver to the top of the cross bar 14. A second transport chain 84 then moves the board 64 along the cross bar 14 to a drop ramp 86 located at a distal end of the cross bar 14. The board 64 slides down the drop ramp 86 to land on a first transport chain 80 of the next lumber dispenser 60.

In this way the lumber handling apparatus becomes entirely modular. FIG. 4 shows six lumber dispensers 60 arranged to supply boards 64 to a jump conveyor 90 and thence to a saw 92. Any one lumber dispenser drive shaft 16 can be operated in order to push a single board into the transport system, and then to the jump conveyor 90. Appropriate timing of the drive shafts 16 means that timber from desired packs 62 can be provided to the jump conveyor 90 at a required rate. When a pack 62 is exhausted, its trolley 32 can be lowered, removed, restocked, and returned without disturbing the operation of the transport chains, and therefore without interrupting continuous supply of timber to the saw 92.

Modifications and variations as would be apparent to a skilled artisan are deemed to be within the scope of the present invention.

1. A lumber dispensing apparatus having:
a pack-supporting platform which is able to be moved vertically;
a row-moving pusher which is able to be moved horizontally;
a rotation-preventing guide located above the pack-supporting platform; and
a lumber restraint located alongside the pack-supporting platform, the lumber restraint being lower than the row-moving pusher by a vertical displacement less than the depth of two timber boards or panels;
whereby when the pack-supporting platform contains a pack of timber, comprising boards or panels arranged in rows and having a top-most row:
the pack-supporting platform is arranged to raise the pack until the top-most row is in position adjacent the row-moving pusher; and
the row-moving pusher is arranged to engage the top-most row of timber at an end remote from the lumber restraint, and to push the top-most row of timber in a transverse direction over the lumber restraint.

2. A lumber dispensing apparatus as claimed in claim 1, wherein the row-moving pusher extends vertically downward from a horizontal housing.

3. A lumber dispensing apparatus as claimed in claim 2, wherein the row-moving pusher is driven by a driving mechanism located within the housing.

4. A lumber dispensing apparatus as claimed in claim 3, wherein the driving mechanism is a continuous loop mechanism.

5. A lumber dispensing apparatus as claimed in claim 1, wherein the pack-supporting platform is raised by means of a hydraulic lift.

6. A lumber dispensing apparatus as claimed in claim 5, wherein the pack supporting platform is located on a trolley sized to locate over the hydraulic lift.

7. A lumber dispensing apparatus as claimed in claim 1, wherein the height of the rotation-preventing guide is variable.

8. A lumber dispensing apparatus as claimed in claim 7, wherein the rotation-preventing guide is associated with a resilient biasing member providing downward pressure on the rotation-preventing guide.

9. A lumber dispensing apparatus as claimed in claim 8, wherein the resilient biasing member is a torsion spring.

10. A lumber dispensing apparatus as claimed in claim 1, wherein the lumber restraint includes at least one lumber receiving guide and at least one lumber dispensing guide, oriented so that lumber can be pushed up the receiving guide and can fall down the dispensing guide.

11. A lumber dispensing apparatus as claimed in claim 10, wherein the lumber restraint includes at least two lumber receiving guides spaced to allow a gap in between them.

12. A lumber dispenser comprising a plurality of lumber dispensing apparatuses, each lumber dispensing apparatus having:
a pack-supporting platform which is able to be moved vertically;
a row-moving pusher which is able to be moved horizontally;
a rotation-preventing guide located above the pack-supporting platform; and
a lumber restraint located alongside the pack-supporting platform, the lumber restraint being lower than the row-moving pusher by a vertical displacement less than the depth of two timber boards or panels;
whereby when the pack-supporting platform contains a pack of timber, comprising boards or panels arranged in rows and having a top-most row:
the pack-supporting platform is arranged to raise the pack until the top-most row is in position adjacent the row-moving pusher; and
the row-moving pusher is arranged to engage the top-most row of timber at an end remote from the lumber restraint, and to push the top-most row of timber in a transverse direction over the lumber restraint.

13. The lumber dispensing apparatuses being arranged in parallel such that they can be associated with a single pack of lumber.

14. A lumber transport apparatus including a plurality of lumber dispensers, each lumber dispenser having at least one continuous loop transporter arranged along its top such that lumber can be transported across from one lumber dispenser over a neighbouring lumber dispenser.

15. A lumber transport apparatus as claimed in claim 12, wherein each lumber dispenser comprises a plurality of lumber dispensing apparatuses, each lumber dispensing apparatus having:
a pack-supporting platform which is able to be moved vertically;
a row-moving pusher which is able to be moved horizontally;
a rotation-preventing guide located above the pack-supporting platform; and
a lumber restraint located alongside the pack-supporting platform, the lumber restraint being lower than the row-moving pusher by a vertical displacement less than the depth of two timber boards or panels;
whereby when the pack-supporting platform contains a pack of timber, comprising boards or panels arranged in rows and having a top-most row:
the pack-supporting platform is arranged to raise the pack until the top-most row is in position adjacent the row-moving pusher; and
the row-moving pusher is arranged to engage the top-most row of timber at an end remote from the lumber restraint, and to push the top-most row of timber in a transverse direction over the lumber restraint.

16. The lumber dispensing apparatuses being arranged in parallel such that they can be associated with a single pack of lumber.

17. A method of dispensing lumber from a pack, the pack comprising boards or panels of timber arranged in rows, the method including the steps of:
locating the pack beneath a rotation-preventing guide;
raising the pack until the topmost row is adjacent the rotation-preventing guide;
pushing the top-most row with a pusher in a transverse direction so that boards or panels of the top-most row sequentially fall over a side of the pack; and
subsequently raising the pack until the new topmost row is adjacent the rotation-preventing guide.
